(19) United States
(12) Patent Application Publication
(10) Pub. No.: US 2015/0138995 A1
(43) Pub. Date: May 21, 2015

(54) METHOD, SYSTEM AND APPARATUS FOR PHASE NOISE CANCELLATION

(71) Applicant: Texas Instruments Incorporated, Dallas, TX (US)

(72) Inventors: Shankar Ram NarayanaMoorthy, Bangalore (IN); Ganesan Thiagarajan, Bangalore (IN); Subhashish Mukherjee, Bangalore (IN)

(73) Assignee: Texas Instruments Incorporated, Dallas, TX (US)

(21) Appl. No.: 14/082,785

(22) Filed: Nov. 18, 2013

(51) Int. Cl. H04W 24/02; H04L 5/00

(52) U.S. Cl. CPC H04W 24/02; H04L 5/0048
USPC 370/252; 370/329

(57) ABSTRACT

According to an aspect of the present disclosure, a baseband signal and a pilot signal are combined for a transmission. The combined signal is then translated to higher frequency band by mixing a local oscillator signal and the combined signal. On the receiver, the pilot signal is used to remove the phase noise in the baseband signal, as both baseband signal and the pilot signal are affected/modified by substantially the same phase noise. In one embodiment, the pilot signal may be selected either centered outside the bandwidth of the base band signal or centered inside the bandwidth of the base band signal with enough guard band around it so that it can be filtered out using filters. The pilot signal is used in a similar fashion to eliminate the effect of the phase noise introduced by the local oscillator present in the tester in testing the receiver device.

### TECHNICAL FIELD

The present disclosure relates generally to signal processing and more specifically to a method, system and apparatus for phase noise cancellation.

### RELATED ART

Signals are generally processed using electronic circuitry or integrated circuits built to perform one or more desired operations. For example, a signal representing or carrying information such as voice, video, images and data) is processed for transmitting and receiving the information over communication channel. Often, the circuitry implemented for processing the signal and a medium (for example, communication channel) through which the signal is transmitted introduce a phase noise. Such phase noise generally degrades the signal-to-noise ratio at the receiver. Such degradation reduces the probability of extracting the information carried or represented by the signal. In another example system, the signal is processed to determine or test the performance of a device, an integrated circuits etc. The phase noise introduced by the testing circuitry/system may reduce the accuracy of the test result.

### SUMMARY

According to an aspect of the present disclosure, a baseband signal and a pilot signal are combined for a transmission. The combined signal is then translated to higher frequency band by mixing a local oscillator signal and the combined signal. On the receiver, the pilot signal is used to remove the phase noise in the baseband signal, as both baseband signal and the pilot signal are affected modified by substantially same phase noise. In one embodiment, the frequency of the pilot signal (tone) is selected to be outside of the frequency band of the baseband signal.

According to another aspect, the pilot signal is used in a similar fashion to eliminate the effect of the phase noise introduced by the local oscillator present in the tester in testing the receiver device. According to another aspect, a receiver device is configured to include a filter and a mixer to separate out the pilot signal and cancel the phase noise respectively. In other embodiment, the mixer for separating the pilot signal is integrated within the tester so that any receiver device may be tested without requiring modification thereof.

Several aspects are described below, with reference to diagrams. It should be understood that numerous specific details, relationships, and methods are set forth to provide a full understanding of the present disclosure. One skilled in the relevant art, however, will readily recognize that the present disclosure can be practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1A is an example system in which various aspects of the present disclosure are seen.

FIG. 1B through FIG. 1E are graphs depicting the effect of the phase noise.

FIG. 2 is a block diagram illustrating the manner in which the phase noise is cancelled in one embodiment of the present disclosure.

FIG. 3 is a block diagram illustrating the phase noise cancellation in an embodiment.

FIG. 4 is a graph depicting the signals on various paths for illustration.

FIG. 5A is a block diagram illustrating a conventional frequency diversity transmission system.

FIG. 5B illustrates the example signals in a conventional frequency diversity system.

FIG. 6A is block diagram illustrating an example frequency diversity transmitter in an embodiment of the present disclosure.

FIG. 6B illustrates the signals of the frequency diversity transmitter in the embodiment.

FIG. 7 is a block diagram of a conventional testing system.

FIG. 8 is a block diagram illustrating the testing of a receiver not implemented to process the pilot signal.

### DETAILED DESCRIPTION

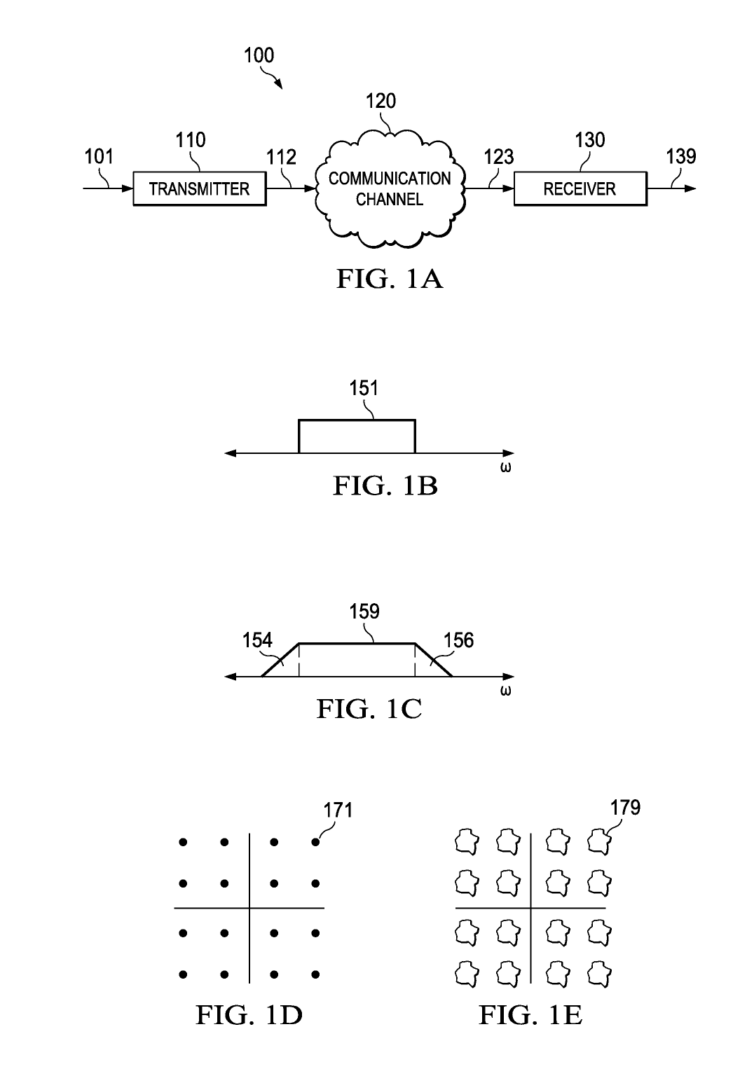

FIG. 1A is an example system in which various aspects of the present disclosure are seen. As shown, the system 100, in one embodiment, comprises a transmitter 110, a communication channel 120, and a receiver 130. Each element is described in further detail below.

The transmitter 110 is configured to process signal carrying information received on path 101. In one embodiment, the transmitter 110 processes the signal for transmission over communication channel 120. The transmitter 110 may perform base band signal processing, modulation, up-conversion, radio frequency amplification and other operations required to transmit the signal on the communication channel 120. The communication channel 120 may be implemented as a wireless channel. For example, the communication channel may be a radio frequency channels occupying RF frequency bands. Alternatively, the communication channel may be a wired channels such as cable network, DSL network etc. Accordingly, the transmitter may process the signal to comply with the requirements of the communication channel 120. The processed signal is provided on path 112.

Receiver 130 receives the signal on path 123 from the communication channel 120. The receiver 130 is configured to extract the original signal/information by processing the received signal in conjunction with the signal processed at the transmitter 110. For example, the receiver 130 may perform filter operation, down conversion, demodulation and other operation(s) necessary to extract the original signal or information.

In one embodiment, the circuitry, components, devices in the transmitter 110, receiver 130 and communication channel 120 may alter the phase of the signal received on path 101 (introduce a phase noise in the signal). Thus, the signal extracted at the receiver may not represent the signal accurately and/or the probability of extracting the information (or data present in the signal) may be reduced. The example effects of the phase noise are further described below.

FIG. 1B is a graph depicting the spectra 151 of an example signal in the frequency domain. FIG. 1C is graph depicting the spectra 159 of the example received signal in the frequency domain. The extended portion 154 and 156 (hereafter referred to as increase in bandwidth) of the received signal spectra 159 represents the undesirable effect of the phase noise introduced by one or more of the transmitter and receiver components, circuitry and the channel.

FIG. 1D is a signal constellation diagram of an example signal. The constellation is shown with 16 points representing the 16 data symbols of an example signal. The point 171 represents one example data symbol of the signal. FIG. 1E is a signal constellation diagram of an example received signal. The spread 179 represents the received data symbol corresponding to point 171 over a period of time. Accordingly, each signal point is shown spread over finite area. The spread 179 is an exemplary representation of the undesired effect of the phase noise. The undesired extension in the spectra (referring to FIG. 1C) and the spread in the constellation (referring to FIG. 1E) due to phase noise reduce the probability of extracting accurate data or information from the received signal.

In one embodiment, the transmitter 110 and receiver 130 are configured to cancel the phase noise and/or reduce the undesirable effect of the phase noise. The manner in which the effect of phase noise may be cancelled or the effect thereof reduced is described in further detail below.

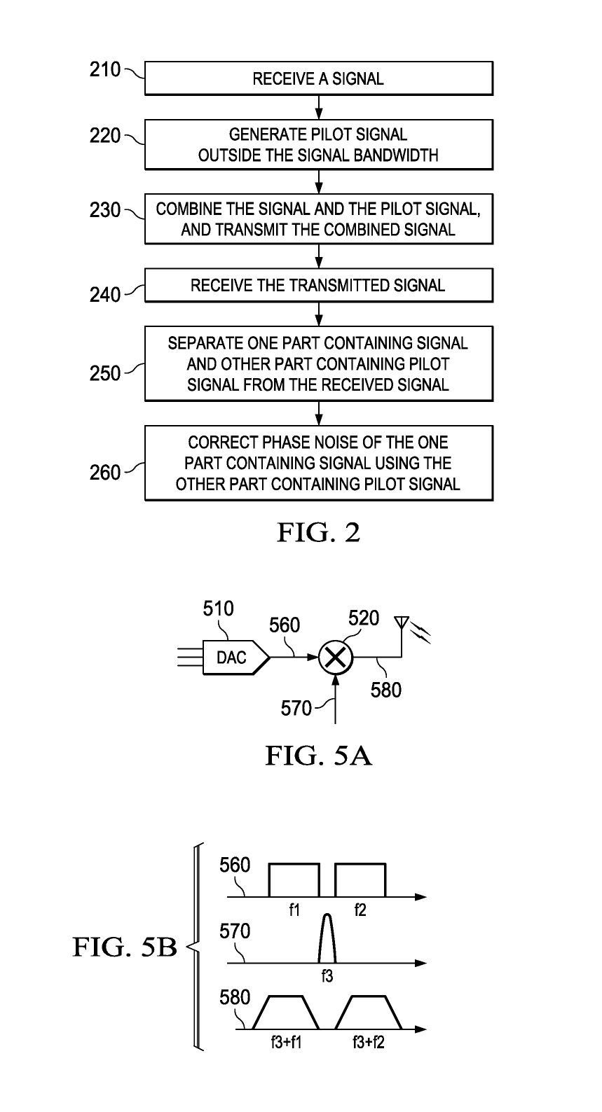

FIG. 2 is a block diagram illustrating the manner in which the phase noise is cancelled in one embodiment of the present disclosure.

In block 210, the transmitter 110 is configured to receive a signal received from a base band signal source such as voice, sensors etc., for transmission over communication channel. The signal may be a base band signal having a finite bandwidth (referred to as signal bandwidth). The transmitter may be configured to receive the signal from an external system through appropriate interface. Alternatively, the signal may be obtained received from a circuit part within the transmitter 110.

In block 220, the transmitter 110 is configured to generate a pilot signal outside the signal bandwidth. The pilot signal may comprise a single frequency signal or narrow band signal compared to the signal bandwidth. The pilot signal may be centered at a frequency slightly outside of the signal bandwidth such that the pilot signal may be separated from the signal using filters or any other known technique for signal separation.

In block 230, the transmitter 110 is configured to process both the signal and the pilot signal for transmission. For example, the transmitter may combine both the signal and the pilot signal (using combiner such as adder) and process the combined signal for transmission. The transmitter performs the desired operations such as filtering, modulation, up-conversion and other operations on the combined signal. The combined signal is then transmitted over the communication channel 120.

In block 240, the receiver 130 is configured receive the transmitted signal. The receiver may receive the transmitted signal from the communication channel 120 through an appropriate interface. For example, RF antennas and corresponding RF receivers such as heterodyne receivers may be employed to receive the transmitted signal. The receiver may be configured to receive the signal in a frequency range covering both the signal and the pilot signal.

In block 250, the receiver 130 is configured separate signal portion and pilot signal from the received signal. In one embodiment, the receiver is configured to down-convert the received signal to base band/intermediate frequency band. The down-converted received signal is passed through different filters to extract there from a signal portion and the pilot signal on two separate paths.

In block 260, the receiver 130 is configured to correct phase noise of the signal portion using the received pilot signal. In one embodiment, the receiver determines the phase noise from the pilot signal. The determined phase noise is used for correcting the phase noise in the signal portion. Alternatively, the pilot signal may be mixed multiplied with the signal to cancel the phase noise. An example embodiment is further described below.

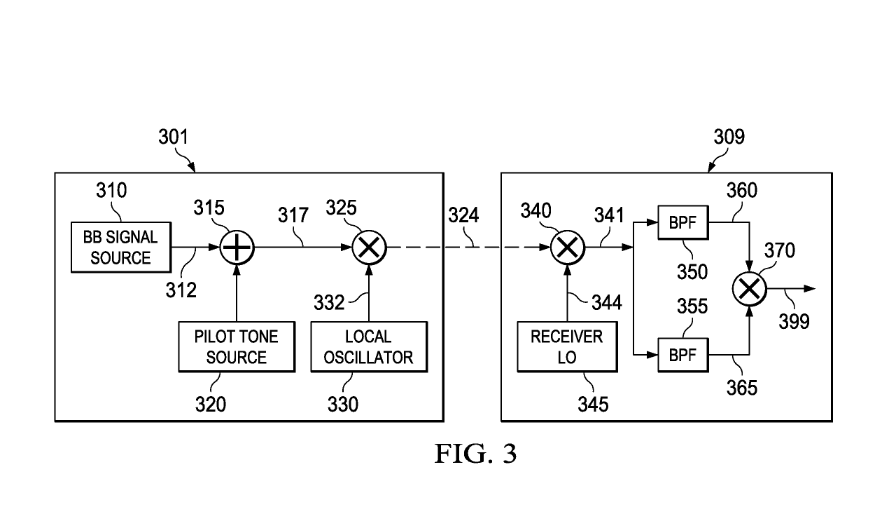

FIG. 3 is a block diagram illustrating phase noise cancellation according to one embodiment. FIG. 3 shows a transmitter 301 and a receiver 309. The transmitter 301 comprises a baseband (BB) signal source 310, a pilot signal source 320, a local oscillator 330, an adder 315 and a mixer 325. The receiver 309 comprises mixers 340 and 370, a receiver local oscillator 345, and band pass filters (BPF) 350 and 355. Each block is described in further detail below.

The baseband signal source 310 provides base band signal (BB signal) for transmission. The base band signal source 310 may comprise circuitry configured to perform baseband signal processing and modulation according to a desired protocol for transmission. The baseband signal source 310 may provide QPSK, BPSK, AM, FM, FDM, OFDM and MSK modulated signals with finite bandwidth, for example. The base band signal may occupy a band of frequencies near zero. In an alternative embodiment, the base band signal source may comprise an external device configured to provide a baseband signal for transmission.

The pilot signal source 320 provides a pilot signal. The pilot signal may comprise a signal of a singular frequency (for example, a sine or a cosine signal). In another embodiment, the pilot signal may comprise a signal with a frequency band that is narrower than the bandwidth of the baseband signal. The pilot signal is selected and centered at a frequency that is outside the band of frequencies of the baseband signal. For example, the pilot signal may be selected such that it may be separated from the baseband signal. In one embodiment, a part of the baseband signal which has enough guard bands around it to be filtered from the baseband signal may be used as pilot signal. In an alternative embodiment, an unused part of the base band signal (for example, the part not carrying any information) may be treated as a pilot signal.

Adder 315 adds the BB signal and the pilot signal to form a combined signal. The addition may be performed in either the time or the frequency domain. The combined signal is provided on path 312. The local oscillator 330 provides a first reference frequency signal of a higher frequency. The local oscillator may be implemented using any known technique. In one embodiment, the local oscillator 330 may comprise a frequency synthesizer. The local oscillator 330 may introduce a phase noise to the first reference frequency signal.

The multiplier 325 multiplies or mixes the reference frequency signal and the combined signal to shift the center frequency of the baseband signal and the pilot signal. Accordingly, the center frequency of the combined signal is shifted by a factor related to the reference frequency (referred to as up-conversion). Further, the phase noise in the reference frequency signal may introduce phase noise in the up-converted combined signal, as is well known in the art. The other components produced by the mixer may be removed using appropriate filters. The up-converted signal is provided on the path 324 representing a channel.

The local oscillator 345 in the receiver 309 provides a second reference frequency signal of a lower frequency. The local oscillator 345 may be similar to the local oscillator 330. The mixer (multiplier) 340 multiplies or mixes the second reference frequency signal and the signal received on path 324 (received signal) to shift the center frequency of the received signal towards baseband (referred to as down-conversion). Accordingly, the center frequency of the received signal is shifted towards baseband by a factor related to the second reference frequency. The other components produced by the mixer may be removed using appropriate filters. The down-converted signal is provided on path 341.

The band pass filter (BPF) 350 is configured to pass baseband signal and stop/attenuate other frequency signals, including the pilot signal. Similarly, the BPF 355 is configured to pass the pilot signal and stop/attenuate the band pass signal. Accordingly, band pass signal separated from pilot tune is provided on path 360. The pilot signal separated from the band pass signal is provided on the path 365. The band pass signal and pilot signal on path 360 and 365 are affected by the phase noise introduced by the mixer 325 and 340.

The multiplier 370 multiplies the baseband signal (affected by the phase noise) on path 360 with the pilot signal (also affected by the phase noise) on the path 365, thereby cancelling/eliminating/reducing the phase noise (introduced by the mixers 325 and 340) to the baseband signal on path 360. The multiplier operation renders the other signal components (as is well known in the art) that are filtered out (not shown). The baseband signal with reduced phase noise is provided on path 399 for further processing. The manner in which the phase noise is reduced is further described below with an example base band signal.

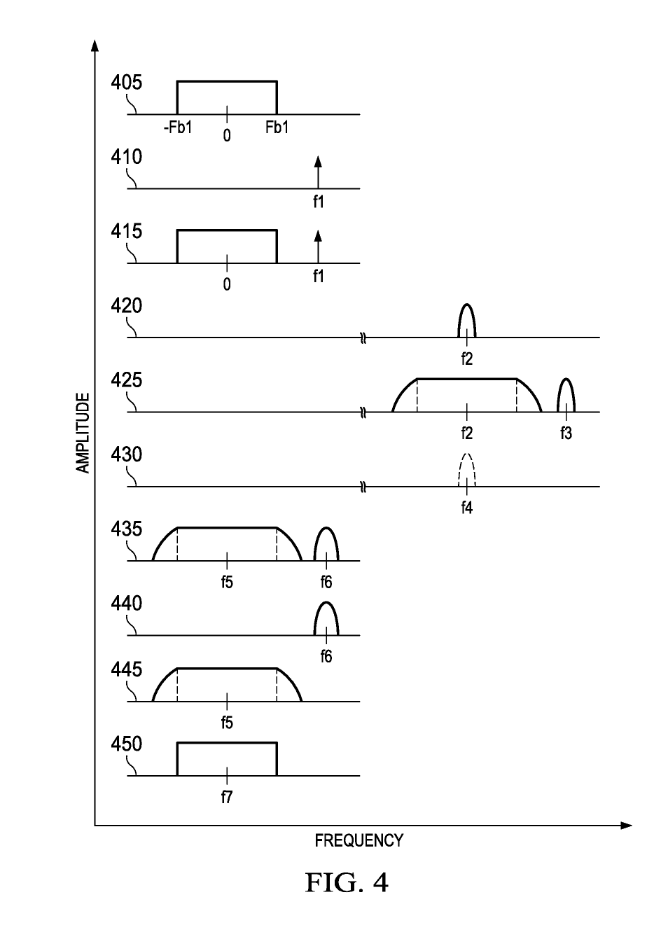

FIG. 4 is a graph depicting the signals on various paths for illustration. The graph represents an example baseband signal from BB signal source 310 provided on path 312. The baseband signal 405 is shown at the center frequency zero and occupying the frequency band from −Fb1 to +Fb1 (a bandwidth of 2Fb1).

The graph 410 represents an example pilot signal centered at frequency f1. The pilot signal is shown as singular frequency signal (such as sine or cosine signal) of frequency f1. However, in an alternative embodiment, the pilot signal may occupy a finite bandwidth. As shown there, the pilot signal is selected outside the baseband signal with sufficient frequency gap for filter operation.

The graph 415 represents the combined signal provided on path 317 from the adder 315. Thus, the combined signal shown in the graph 415 is processed for transmission. The graph 420 represents a first reference frequency signal provided by the local oscillator 330 on path 332. The first reference frequency signal in graph 420 is shown with center frequency f2 occupying a finite bandwidth. The finite bandwidth represents phase noise introduced by the local oscillator 330. The frequency f2 may be selected in RF communication bands like VHF, UHF, etc.,

The graph 425 represents the output of the mixer 325 provided on path 324. Accordingly, the combined signal in graph 415 (baseband signal 405 and pilot signal 410) are shifted to higher frequency band. In one embodiment, the frequency f3 may be substantially equal to f1+f2. The effect of the phase noise due to the local oscillator 330 is shown as the expanded bandwidth.

The graph 430 represents a second reference frequency signal provided by the local oscillator 345 on path 344. The second reference frequency signal 430 is shown with center frequency f4 occupying a finite bandwidth. The finite bandwidth represents phase noise introduced by the local oscillator 345. The frequency 14 may be chosen to down convert the signal to base band region. In one embodiment, the frequency f4 may be selected substantially equal to the frequency 12 suitable for further processing.

The graph 435 represents the signal on path 346 provided by the mixer 340. The signal 435 is shown centered at frequency f5 and f6. The frequency 15 may be substantially equal to f2−f4 and f6 may be substantially equal to f3−f4. Thus, the signal 435 represents the down-converted received signal. The effect of the phase noise due to the local oscillator 345 is shown as expanded bandwidth of the signal. The signal 440 represents the signal on path 365 provided by the band pass filter 355. Thus, the signal on path 365 is shown without the baseband signal components.

The graph 445 represents the signal on path 360 provided by band pass filter 350. The signal on path 360 is shown comprising only the baseband signal components. The graph 450 represents the signal on path 399 provides by the mixer 370 (unwanted signal component filtered). As may be seen, the effect of the phase noise introduced by the local oscillator 330 and 345 are cancelled and the baseband signal without the extended bandwidth (centered at frequency f7 that is substantially equal to the pilot signal) is provided on the path 399. Thus, the pilot signal is advantageously used to remove/cancel the phase noise introduced by the components of the transmitter and receiver.

In an alternative embodiment, an unused part of the signal may be used in place of pilot signal to cancel the phase noise. In that, the band pass filter 355 may be configured to pass only the unused part of the signal. Alternatively, any pilot signals used for synchronization purposes (for example in OFDM system) may be advantageously used for cancellation of the phase noise. An example embodiment in which part of the signal is advantageously used for phase noise cancellation is illustrated below.

FIG. 5A is a block diagram illustrating a conventional frequency diversity transmission system. FIG. 5B illustrates the example signals in the conventional frequency diversity system. The example signal 560 for transmission is shown comprising multiple copies of the same information centered at two different frequencies f1 and f2. Generally, the same information is transmitted on two different frequency bands to overcome jamming of the receiver as is well known in the art.

The DAC (Digital to Analog Converter) 510 converts the digital signal into analog signal for transmission. The mixer 520 up-converts analog form of the signal 560 using a reference frequency signal 570. The reference frequency signal 570 is generated using a local oscillator. The expanded bands (slope on either side) in the up-converted signal 580 represent the phase noise introduced by the local oscillator (or reference frequency signal). Such phase noise may degrade the signal-to-noise ratio at the receiver, thereby reducing the probability of extracting the information accurately.

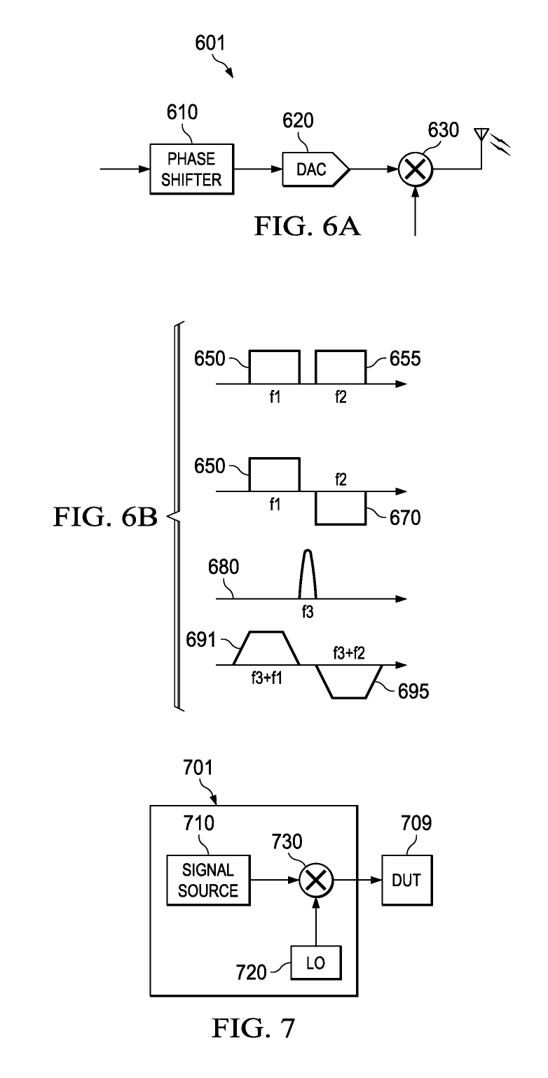

FIG. 6A is block diagram illustrating an example frequency diversity transmitter 601 in an embodiment of the present disclosure. FIG. 6B illustrates the signals of the frequency diversity transmitter in the embodiment. As shown there, the transmitter 601 receives two copies of information on frequency band 650 and 655. The phase shifter 610 converts the phase of one of the frequency band (655 for example) by 180 degrees. Accordingly, the frequency band 650 and the phase shifted band 670 (in FIG. 6B) are provided to DAC 620. The DAC 620 converts the signal represented by the frequency band 650 and 670 to analog form for transmission. The mixer 630 up-converts the signal received from the DAC 620. The up-converted copies 691 and 695 of the signals 650 and 670 are shown with the slope on either side depicting the phase noise introduced by the local oscillators and mixer 630.

However, due to the phase shifted versions of the copies of frequency bands 650 and 670, the phase noise in 691 and 695 introduced at the transmitter mixer 630 may be obtained as a difference of phase between the frequency band 650 and 670. Thus, the phase noise may be effectively cancelled or removed. The manner in which the effect of phase noise may be removed in a tester testing a device is further described below,

FIG. 7 is a block diagram of a conventional testing system. The block diagram is shown comprising a tester 701 and the device under test (DUT) 709. The tester 701 is shown comprising a signal source 710, a local oscillator 720 and a mixer 730. The signal source 710 provides a reference signal for testing. The reference signal is up-converted (frequency translated) using local oscillator 720 and the mixer 730. The up-converted signal is provided to DUT (for example a receiver) 709. The signal extracted from the receiver is compared with signal provided by the signal source 710 to estimate the performance of the DUT 709. However, the result of such test may not represent the performance of the receiver (DUT) accurately, as the local oscillator 720 (and the mixer 730) in the tester 701 has introduced a phase noise in the test signal provided to the DUT 709. Thus, the estimated error may not reflect error due to the DUT/receiver 709 alone. The manner in which the testing may be performed accurately is described below in further detail.

In one embodiment, the transmitter 301 of FIG. 3 may be configured to operate as a tester. The receiver 309 of FIG. 3 may represent a receiver DUT. In one embodiment, receiver 309 may comprise an integrated circuit configured to receive a test signal through a wireless antenna or through an interface I/O pin. Thus, the interface path 324 may be implemented as wired communication line. The local oscillator 330 may be implemented as a low cost local oscillator. The base band signal source 310 and pilot signal source 320 are implemented as a base band signal and signal generator respectively.

Accordingly, the magnitude and phase angle of the baseband signal may be represented as; BB(t) and φ_{BB}(t). The pilot signal may be represented as ωₚᵢₗₒₜ. Thus, the signal on path 324 may be represented as;

A₀ cos [(ω_{c}+ωₚᵢₗₒₜ)t+φₜₓ(t)]+A₁ cos [ω_{c}t+Φ_{BB}(t)+φₜₓ(t)]*BB(t) (1)

wherein ω_{c} represents the center frequency of the local oscillator 330, the φₜₓ(t) represents the phase noise of the transmitter/tester 301, A₀ and A₁ represents the magnitude of the corresponding signal components.

The signal on path 344 generated by the local oscillator 345 may be represented as:

A₂*cos [(ω_{c}−ω_{IF})t+φₜₓ(t)] (2)

wherein ω_{IF} represents the center frequency of the local oscillator 345 and φᵣₓ(t) represents the phase noise introduced by the receiver LO 345.

The signal on path 360 (pilot signal component) after the BPF 350 may be represented as:

A₃*cos [(ω_{IF}+ω_{Pilot})*t+φₜₓ(t)−φᵣₓ(t))] (3)

Similarly, the signal on path 365 (base band signal component) after the BPF 355 may be represented as:

A₄*cos(ω_{IF}*t+φ_{BB}(t)+φₜₓ(t)−φᵣₓ(t)),*BB(t) (4)

The signal on path 399 may be obtained by multiplying relation 3 and 4 as:

A₅*cos [(ωₚᵢₗₒₜ*t−φ_{BB}(t))*BB(t)+A₅*cos(2*ω_{IF}+ω_{Pilot})*t+Φ_{BB}(t)+2*(φₜₓ(t)−φᵣₓ(t))]*BB(t) (5)

In the relation 5, first term A₅*cos(ωₚᵢₗₒₜ*t−φ_{BB}(t))*BB(t) represents the base band signal without the phase noise. The second part may be filtered using a band pass filter (not shown). Accordingly, receiver device may be tested accurately or the effect of the phase noise may be reduced.

However, the tester 301 may test the devices that are configured or implemented to separate/process the pilot signal (similar to the receiver 309). The manner in which the receivers or devices that are not configured process the pilot signal may be tested is further described below.

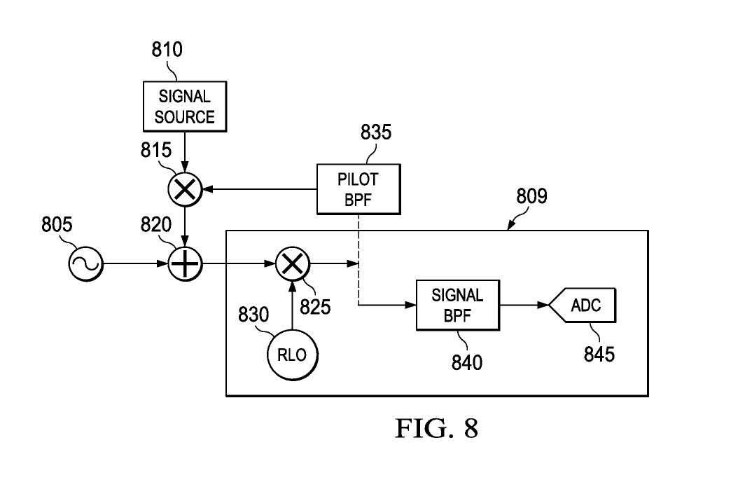

FIG. 8 is a block diagram illustrating the testing of a receiver not implemented to process the pilot signal. This block diagram is shown comprising DUT receiver 809, pilot signal source 805, transmitter/signal source 810, external mixer 815, adder 820, and pilot BPF 835. The receiver 809 is shown comprising the receiver local oscillator (RLO) 830, receiver mixer 825, signal BPF 940 and ADC 845. Each block is described below in further detail.

The signal source 810 provides an information signal centered at frequency ω_{c} for testing. In alternative embodiment, the signal source 810 may be a transmitter transmitting an information signal offset by a carrier frequency ω_{c}. The test signal may be represented as:

A₁*cos [(ω_{c}t+Φ_{BB}(t)]*BB(t) (6)

The pilot signal source 805 generates a pilot signal for phase noise correction. The pilot signal is shifted offset by the carrier frequency ω_{c}. The pilot signal is provided on path 802 and may be represented as:

(A₂*cos [(ω_{c}−ωₚᵢₗₒₜ)*t] (7)

The Receiver local oscillator (RLO) 830 generates a receiver reference frequency signal of frequency ω_{if} with a frequency offset by the carrier frequency ω_{c}. The receiver reference signal may be represented as:

A₃*cos [(ω_{c}−ω_{IF})*t+φᵣₓ(t)] (8)

Wherein φᵣₓ(t) represents the phase noise of the receiver local oscillator.

The external mixer 815 multiplies the signal received from the pilot BPF 835 and the test signal. The multiplied signal from the external mixer is provided on path 812. The adder 820 adds the multiplied signal on path 812 and the pilot signal on path 802. The added/combined signal is provided on path 822 as the input signal to the receiver mixer 825. The receiver mixer 825 multiplies the signal on path 822 and the receiver reference frequency signal (represented by relation 8). The output of the receiver mixer 825 is tapped and provided to external band pass filter configured to pass the pilot tone ω_{c}−ωₚᵢₗₒₜ. The output of the pilot BPF may be represented as:

A₄*cos [(ω_{IF}−ωₚᵢₗₒₜ)*t+φᵣₓ(t)

Under the steady state, the signal on path 812 may be represented as:

Aₛ*BB(t)*{cos [(ω_{c}−ω_{IF}+ωₚᵢₗₒₜ)*t+φᵣₓ(t)+*ΦBB(t)]+cos [(ω_{c}+ω_{IF}−ωₚᵢₗₒₜ)*t−φᵣₓ(t)+*ΦBB(t)]} (9)

Accordingly, the output of the receiver mixer comprise the three components ω_{IF}−ωₚᵢₗₒₜ, test signal BB(t) centered at the ωₚᵢₗₒₜ and double phase noise component centered at 2ω_{IF}−ωₚᵢₗₒₜ. Thus, the test signal BB(t) may obtained by passing through the band pass filter 840 configured to pass the test signal. The test signal may be converted to digital data using the ADC 245 for determining the performance of the received device in digital domain. Thus, any receiver device may be tested accurately by using the above technique.

While various examples of the present disclosure have been described above, it should be understood that they have been presented by way of example, and not limitation. Thus, the breadth and scope of the present disclosure should not be limited by any of the above-described examples, but should be defined in accordance with the following claims and their equivalents.

What is claimed is:

1. A method comprising:
combining a first signal and a pilot signal to form a combined signal;
processing the combined signal to form a translated combined signal;
separating a first part and a second part from the translated combined signal; and
cancelling a phase noise in the first part using the second part.

2. The method of claim 1, wherein the first part comprises the first signal modified by the phase noise and wherein the second part comprises the pilot signal modified by the phase noise.

3. The method of claim 2, wherein the phase noise is introduced by the processing.

4. The method of claim 3, wherein the pilot signal is outside of a first frequency band occupied by the first signal.

5. The method of claim 4, wherein processing comprises mixing the combined signal with a first reference carrier.

6. The method of claim 5, further comprising extracting information from the first part after the cancelling.

7. The method of claim 6, wherein the pilot signal comprises a substantially single frequency narrow band signal centered outside the first frequency band, thereby enabling separation by filtering.

8. The method of claim 7, wherein the translated combined signal comprises an up-converted radio frequency signal.

9. The method of claim 6, wherein the pilot signal comprises a 180 degrees phase translated replica of the first signal occupying a second frequency band, wherein the pilot signal and the first signal together forming a diversity signal for transmission.

10. A communication system comprising:
a combiner configured to combine a first signal carrying an information and a pilot signal to form a combined signal;
a first mixer configured to process the combined signal to form a translated combined signal;
a filter configured to separate a first part and a second part from the translated combined signal; and
a second mixer configured to cancel a phase noise in the first part using the second part.

11. The communication system of claim 10, wherein the first part comprises the first signal modified by the phase noise and the second part comprises the pilot signal modified by the phase noise, wherein the phase noise is introduced by the first mixer.

12. The communication system of claim 11, further comprising a first local oscillator configured to provide the pilot signal outside of a first frequency band occupied by the first signal.

13. The communication system claim 12, wherein the first mixer is further configured to mix the combined signal with a first carrier of a second frequency, wherein the translated combined signal comprises an up-converted combined signal.

14. The communication system claim 13, wherein the pilot signal comprises a substantially single frequency narrow band signal with enough guard band around enabling separation by filtering.

15. The communication system claim 13, further comprising a transmitter and a receiver, wherein the combiner and the first mixer are operative in the transmitter, and the filter and the second mixer are operative in the receiver.

16. A method of testing a receiver device comprising:
combining a first signal and a pilot signal to form a combined signal;
mixing the combined signal with a first carrier to form a test signal for testing the receiver device, wherein the mixing introduces a first phase noise in the test signal;
providing the test signal to the receiver device, the receiver device being configured to receive the test signal and to extract a first signal there from;
separating a first part and a second part from the test signal in the receiver device; and
cancelling a phase noise in the first part using the second part;
extracting the first signal from the first part after cancelling to measure a performance of the receiver device.

17. The method of claim 16, wherein the first part comprises the first signal modified by the phase noise and wherein the second part comprises the pilot signal modified by the phase noise.

18. The method of claim 17, wherein the pilot signal comprises a substantially narrow band signal centered outside a first frequency band occupied by the first signal, thereby enabling separation by filtering.

19. The method of claim 18, further comprising;
mixing the test signal with a second carrier to form a down-converted test signal;
separating a first part comprising pilot signal from the down-converted test signal; and
mixing the first signal with the pilot signal to form a second signal, wherein the combiner combining the second signal and the pilot signal to form the combined signal.

20. A tester comprising;
a signal source configured to provide a baseband signal;
a first local oscillator configured to generate a first pilot signal;
a mixer configured to multiply the baseband signal and a second pilot signal to form a modified baseband signal;
an adder configured to add the modified baseband signal and the first pilot signal to form a test signal;
a receiver mixer configured to multiply the test signal and an intermediate frequency signal to form a down-converted test signal; and
a filter configured to extract the second pilot signal from the test signal, wherein the second pilot signal represents the first pilot signal modified by a first phase noise introduced by the mixer and modified by a second phase noise introduced by the receiver mixer.

21. The method of claim 20, wherein the first pilot signal comprises a substantially single signal narrow band signal centered outside a first frequency band occupied by the baseband signal, thereby enabling separation by filtering.
